(19) United States
(12) Patent Application Publication
(10) Pub. No.: US 2026/0086665 A1
(43) Pub. Date: Mar. 26, 2026

(54) SIGNAL TRANSMITTER ADAPTED TO MANIPULATION BEHAVIOR AND OPERATING METHOD THEREOF

(71) Applicant: DEXIN CORPORATION, New Taipei City (TW)

(72) Inventor: HO-LUNG LU, NEW TAIPEI CITY (TW)

(21) Appl. No.: 18/967,774

(22) Filed: Dec. 4, 2024

(30) Foreign Application Priority Data
Sep. 20, 2024 (TW) 113135633

(51) Int. Cl. G06F 3/041; G06F 3/01

(52) U.S. Cl. CPC G06F 3/0412; G06F 3/017; G06F 3/0416

(57) ABSTRACT

A signal transmitter adapted to manipulation behavior and a method for operating the same are provided. The signal transmitter includes a microcontroller and a signal transmitting circuit. The signal transmitting circuit is used to establish a connection between an input device and a computer host. The microcontroller is used to receive input signals transmitted by the input device and extract manipulation data from the input signals. The manipulation data can be a clicking rate, a rolling rate or a touch-traveling distance. The manipulation data is used to derive a manipulation behavior of a user and determine a manipulation instruction. The manipulation instruction is transmitted to the computer host by the signal transmitting circuit. An operating system operated in the computer host then executes the manipulation instruction.

### CROSS-REFERENCE TO RELATED PATENT APPLICATION

This application claims the benefit of priority to Taiwan Patent Application No. 113135633, filed on Sep. 20, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a method for processing behavior of a user who manipulates an input device, and more particularly to a signal transmitter and a method for operating the signal transmitter adapted to manipulation behavior that can determine a manipulation instruction based on manipulation data provided by the signal transmitter.

### BACKGROUND OF THE DISCLOSURE

A conventional wireless input device such as a wireless computer mouse, a touch pad or a keyboard that requires a signal transmitter (i.e., a wireless dongle) to connect with a computer host via a communication port (e.g., a USB interface). Main circuits of the signal transmitter include a microcontroller used to process signals to be transmitted between the connected devices, a transmission circuit used to transmit the signals and an antenna. When the signal transmitter is in operation, the signal transmitter receives input signals generated by a wireless input device via the antenna. The microcontroller converts the input signals into signals in a specific format and transmits the signals to the computer host. An operating system operated in the computer host then processes the signals to form an input instruction.

Correspondingly, in a specific application, the operating system can generate the signals feedback to the wireless input device via the signal transmitter. The operating status can be indicated by lights, sounds or vibrations of the wireless input device.

### SUMMARY OF THE DISCLOSURE

Rather than the conventional technologies for processing signals to be transmitted between a computer system and an input device, provided in the present disclosure is a signal transmitter and a method for operating the signal transmitter adapted to manipulation behavior. The method operated in the signal transmitter can directly determine a manipulation instruction based on manipulation data generated by a user who manipulates the input device. The manipulation instruction is then provided to an operating system operated in a computer host for performing the manipulation instruction.

According to one embodiment of the signal transmitter, main circuit components of the signal transmitter include a microcontroller and a signal transmitting circuit. The signal transmitting circuit is used to establish a connection for transmitting signals between the input device (e.g., a computer mouse, a keyboard, or a touch pad) and the computer host.

In the method, the microcontroller receives input signals transmitted from the input device via the signal transmitting circuit. In the signal transmitter, the manipulation data can be extracted from the input signals, and the manipulation data is referred to for determining the manipulation instruction. The manipulation instruction is then transmitted to the computer host via a specific communication port by the signal transmitting circuit, and an operating system operated in the computer host performs the manipulation instruction to be determined in the signal transmitter.

Preferably, the manipulation data being generated when the user manipulates the input device can be a clicking rate of clicking on an input interface (e.g., a button, left and right buttons or a touch interface) of the input device, a rolling rate of rolling an input interface (e.g., a mouse wheel), or a touch-traveling distance formed by operating the touch pad.

Further, the signal transmitter adapted to the manipulation behavior also includes a memory that is electrically connected with the microcontroller. The memory stores a lookup table that records various kinds of manipulation data and various corresponding manipulation instructions, and the microcontroller determines the manipulation instruction based on the manipulation data in real time.

The clicking rate indicates a number of times that a button element of the input device is clicked within a unit time. The rolling rate indicates a number of times, a number of steps or a length that a rolling input element of the input device is rolled within a unit time. The touch-traveling distance indicates a distance that is formed by using a gesture or a control device to travel over the input device within a unit time.

Further, the lookup table stored in the memory is editable, and an editing program executed by the operating system operated in the computer host is used for editing the lookup table.

In one further aspect, the memory also stores a product ID. The microcontroller relies on the product ID to identify the input device and determines the manipulation instruction according to the manipulation data with respect to the input device.

Further, in an aspect of the present disclosure, the memory stores a rate-time relation curve, in which each of curve sections in the rate-time relation curve corresponds to one of the manipulation instructions, and the microcontroller calculates an input rate that changes over time based on the input signals, and obtains the manipulation instruction as comparing with the rate-time relation curve.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic diagram depicting a signal transmitter adapted to manipulation behavior according to one embodiment of the present disclosure;

FIG. 2 is a block diagram illustrating circuit blocks of the signal transmitter adapted to manipulation behavior according to one embodiment of the present disclosure;

FIG. 3 is a flowchart illustrating a method for operating a signal transmitter adapted to manipulation behavior according to one embodiment of the present disclosure;

FIG. 4 is a flowchart illustrating a process of determining a manipulation instruction in the method for operating a signal transmitter adapted to manipulation behavior according to one embodiment of the present disclosure; and

FIG. 5 is an exemplary diagram depicting a rate-time relation curve that is referred to for determining the manipulation instruction in the method for operating a signal transmitter adapted to manipulation behavior according to one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

The present disclosure relates to a method for operating a signal transmitter adapted to manipulation behavior. The signal transmitter is a transmitter that provides various types of input devices to connect with a computer host. The signal transmitter can be a wireless dongle used to connect with the computer host via a specific communication port (e.g., USB). The input device is preferably a computer mouse, a stylus, a presenter, a wireless keyboard, a touch pad or a game controller (e.g., a joystick) that wirelessly connects with the computer host. In addition, the signal transmitter can also be applied to a transmission circuit adapted to the input device that is connected with the computer host in a wired manner.

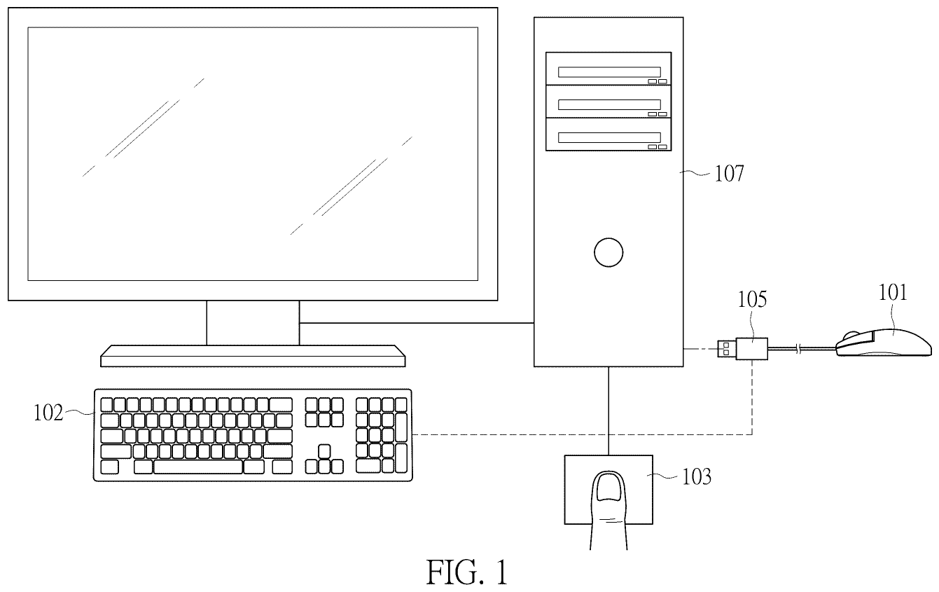

FIG. 1 is a schematic diagram depicting the signal transmitter adapted to manipulation behavior according to one embodiment of the present disclosure.

A computer host 107 shown in the diagram connects with any of various types of input devices via a specific communication port. The input device can be a wired or wireless input device that is preferably connected with the computer host 107 via a signal transmitter 105. As shown in the diagram, a first input device 101 is such as a wireless computer mouse, a second input device 102 is such as a wireless keyboard, and a third input device 103 is such as a wireless touch pad. It is worth noting that the various types of input devices connected with the signal transmitter 105 adapted to manipulation behavior are not limited to the devices shown in the diagram.

The method is operated in firmware of the signal transmitter 105. When the user manipulates the first input device 101, the second input device 102 or the third input device 103 to generate signals inputted to the computer host 107. One of the main objectives is to extract manipulation data from the input signals in the signal transmitter 105 by performing software sequences in the computer host 107. The manipulation data can be extracted from different input devices. Taking a computer mouse as an example, the manipulation data can be a number of times the left and right buttons are clicked by the user within a unit time, and an action such as a single-clicking, double-clicking or fast multi-clicking can be determined. Furthermore, a number of steps of a wheel of the computer mouse being rolled within a unit time can reflect a specific manipulation instruction with respect to an action such as turning a page or navigating multiple pages. For a computer keyboard, an action such as hitting a key or a combination of keys a number of times within a unit time or pressing the key for a while can be used to determine a corresponding manipulation instruction. For a touch pad, an action such as continuously hitting the touch pad a number of times within a unit time, or performing a specific swiping gesture across the surface of the touch pad for a distance within a unit time can be used to determine another corresponding manipulation instruction.

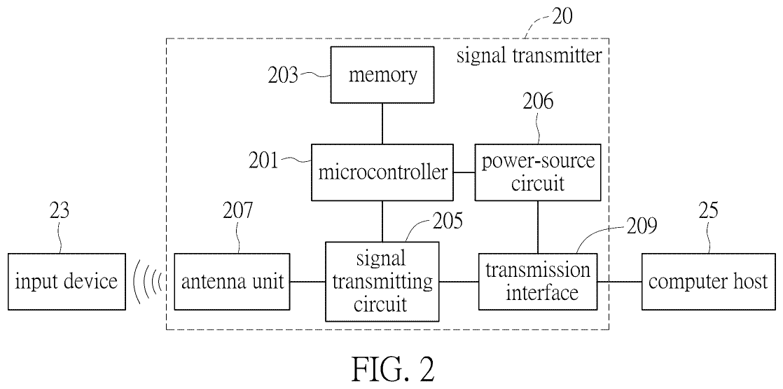

Reference is made to FIG. 2, which is a block diagram depicting circuits of the signal transmitter adapted to a manipulation behavior according to one embodiment of the present disclosure.

Main components of the signal transmitter 20 shown in the diagram include a microcontroller 201 and multiple circuit components (e.g., a signal transmitting circuit 205) electrically connected with the microcontroller 201. For example, the signal transmitter 20 is used to establish a connection for transmitting signals between an input device 23 (e.g., the first input device 101, the second input device 102 or the third input device 103 of FIG. 1) and the computer host 25.

In certain embodiments, signal transmitter 20 includes a memory 203 that is electrically connected with the microcontroller 201. The memory 203 is used to store data requisite for operating the signal transmitter 20. The data stored in the memory 203 includes a lookup table described below and a rate-time relation curve. The signal transmitter 20 includes a power-source circuit 206 that is used to manage the power supplied to the signal transmitter 20 from the computer host 25.

Taking a wireless input device having the signal transmitter 20 as an example, the signal transmitting circuit 205 connects with the input device 23 by an antenna unit 207 in a wireless communication manner and connects with the computer host 25 via a transmission interface 209. It should be noted that the present example is not used to limit the scope of the invention of present disclosure. The signal transmitting circuit 205 is such as a transmission circuit that operates with a Bluetooth™M communication protocol and connects with the input device 23 via an antenna under the Bluetooth™ communication protocol. The signal transmitting circuit 205 is used to process input signals transmitted by the input device 23 through the Bluetooth™ communication protocol. The signal transmitting circuit 205 can be a transmission circuit that operates 2.4 GHz wireless signals. The signal transmitting circuit 205 connects with the input device via an antenna with a corresponding frequency so as to process the 2.4 GHz wireless signals.

On the other hand, in one of the embodiments, the signal transmitting circuit 205 can connect with the computer host 25 via a transmission interface 209 that is such as a universal serial bus (USB). The signal transmitting circuit 205 converts the wireless signals that are received via the antenna unit 207 into signals in compliance with the universal serial bus, and then transmits the signals to the computer host 25. Similarly, the signals transmitted by the computer host 25 in compliance with the universal serial bus are converted into the wireless signals to be fed back to the input device 23.

The microcontroller 201 is used to process the signals received by the signal transmitting circuit 205 in between the input device 23 and the computer host 25, and the signals are also processed by the signal transmitting circuit 205 under different communication protocols and specifications. In the method for operating a signal transmitter adapted to manipulation behavior of the present disclosure, the microcontroller 201 retrieves the input signals transmitted by the input device 23 from the signal transmitting circuit 205, and especially extracts the manipulation data from the input signals. The microcontroller 201 then determines a manipulation instruction based on the manipulation data, and then transmits the manipulation instruction to the computer host 25 via the signal transmitting circuit 205. After that, an operating system operated in the computer host 25 performs the manipulation instruction.

According to one of the embodiments of the present disclosure, the manipulation data obtained by the microcontroller 201 can be a clicking rate such as a number of key strokes per second when continuously manipulating the input device having a wheel or a touch pad, a rolling rate such as a number of times of rolling the input device per second or a length of rolling the input device per second or a touch-traveling distance that is a length of touching the input device per second. The manipulation data can therefore be used to determine a purpose of operation. The manipulation data can be re-calculated when an interval between consecutive operations reaches a preset threshold.

Taking the clicking rate as an example, a number of times when a user clicks on any or two of the left and right buttons of a computer mouse (or a clickable touch pad or a keyboard) or other specific key within a unit time can be used to determine a purpose that the user manipulates the buttons with one single click, double clicks or multiple consecutive clicks of the computer mouse.

The manipulation data can be the rolling rate when manipulating the input device. For example, the rolling rate is obtained by calculating a number of rolling steps within a unit time when the user manipulates the wheel of the computer mouse to roll a distance. The distance the wheel is rolled in a short period of time can be used to determine a purpose of the user manipulating the wheel. In an instance, when the rolling rate is lower than a threshold set by the system, the user's purpose can be determined as turning a web page or turning one page of a document; when the rolling rate is not too low, the user's purpose can be determined as turning multiple pages once; or, when the rolling rate is high, the user's purpose is determined as turning to a bottom page.

The manipulation data can also be the above-mentioned touch-traveling distance when manipulating the input device. For example, the touch-traveling distance can be an operating distance when the user performs a gesture on the touch pad within a unit time. A continuous action of the user's finger moving on the touch pad corresponds to a purpose of the user's manipulation. For example, when the user clicks on the input device for a distance only once within a unit time, it is determined that the user browses a web page or a document slowly; when the user clicks on the input device multiple times slowly for a distance, it is determined that the user turns the pages quickly; or, when the user clicks on the input device for a distance once but quickly, it is determined that the user turns multiple pages once.

Further, with a television or a game console as an example, the input device can be a controller of a video game. If the user manipulates a lever of the controller toward a direction a number of times within a unit time, acceleration can be calculated so as to determine a manipulation instruction that drives the video game to accelerate an action.

According to certain embodiments, the manipulation instructions to be determined based on the various manipulation data can be used to establish a lookup table. The lookup table can be stored to the memory 203. The lookup table records various manipulation data and the corresponding manipulation instructions. Accordingly, the microcontroller 201 can rely on the manipulation data extracted from the input signals to determine the manipulation instructions.

Further, in one of the embodiments, the lookup table stored in the memory 203 is editable and provided for the user to manipulate an operating system operated in the computer host to execute an editing program. The editable program is used to edit the lookup table, and the user is allowed to define various types of manipulation behaviors corresponding to the manipulation instructions.

In one further aspect, the memory 203 stores product IDs. Each of the product IDs corresponds to one of the input devices. The microcontroller 201 can recognize the input device 23 (e.g., a computer mouse, a touch pad or a keyboard) according to the product ID. Therefore, the microcontroller 201 can correctly determine the manipulation instruction with respect to the manipulation data of the input device 23.

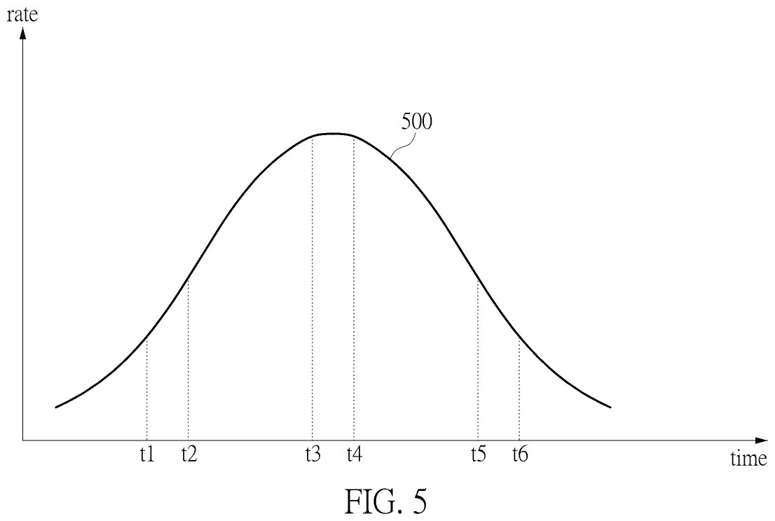

In one further embodiment of the present disclosure, the memory 203 also stores a rate-time relation curve that refers to the embodiment of FIG. 5. A rate-time relation curve 500 that is referred to for determining the manipulation instruction in the method for operating a signal transmitter adapted to manipulation behavior is exemplarily shown in FIG. 5. A vertical axis of the chart shown in FIG. 5 represents rates and a horizontal axis of the chart represents time.

The horizontal axis of the chart schematically labels several time points t1, t2, t3, t4, t5 and t6 that respectively divide the curve into multiple curve sections. For example, the time points t1 to t2 cover a first curve section, the time points t3 to t4 cover a second curve section, and the time points t5 to t6 cover a third curve section. Each of the curve sections corresponds to a specific manipulation instruction. The microcontroller 201 can calculate an input rate that changes over time according to the input signals and obtain the manipulation instruction as compared with the rate-time relation curve 500.

In an exemplary example, when an acceleration of pressing the button(s) or rolling the wheel of the input device 23 or another acceleration of touching the input device 23 for a distance by a gesture is calculated based on the input signals. If the clicking rate or the rolling rate matches one of the curve sections over the rate-time relation curve 500, one of the manipulation instructions can be determined.

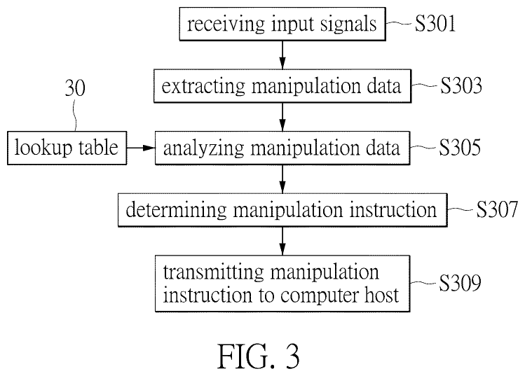

Reference is made to FIG. 3, which is a flowchart illustrating the method for operating a signal transmitter adapted to manipulation behavior in one of the embodiments of the present disclosure.

According to the embodiment of FIG. 3, the signal transmitter is sued to establish a connection between an input device and a computer host. The signal transmitter can identify the connected input device according to a product ID, and receives input signals generated when a user manipulates the input device (step S301). Manipulation data can also be extracted from the input signals (step S303). For example, the manipulation data to be generated by manipulating the input device can be a rate of pressing an input interface (e.g., keys, left and right buttons or a touch pad) of the input device, a rate of rolling the input interface (e.g., a wheel) of the input device, or a touch-traveling distance when touching the touch pad.

After that, the manipulation data is analyzed (step S305). After querying a lookup table 30, a microcontroller of the signal transmitter can determine a manipulation instruction based on the manipulation data in real time (step S307). The manipulation instruction can then be transmitted to the computer host by a signal transmitting circuit via a communication port (step S309). An operating system operated in the computer host then performs the manipulation instruction determined by the signal transmitter.

One of the methods for determining the manipulation instruction is to query the lookup table 30 stored in a memory of the signal transmitter based on the manipulation data. The lookup table 30 records various manipulation data and multiple corresponding manipulation instructions. The lookup table 30 can also record rates and accelerations calculated from the manipulation data with respect to various manipulation behaviors. The manipulation instructions can be obtained by comparing the rates or the accelerations depicted on the rate-time relation curve with the lookup table 30 of FIG. 5.

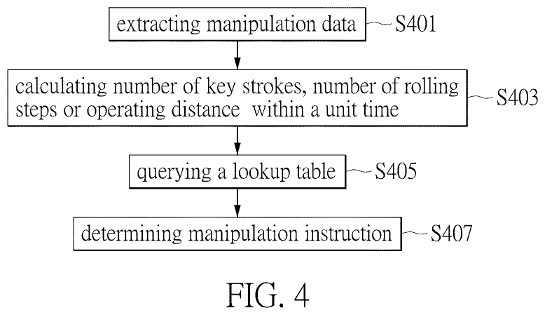

Reference is made to FIG. 4, which is a flowchart illustrating a process of determining the manipulation instruction in the method for operating the signal transmitter according to the embodiment of the present disclosure.

In the flowchart shown in FIG. 4, the signal transmitter connected with the computer host retrieves the manipulation data extracted from the input signals generated by the input device (step S401). The manipulation data can be a clicking rate, a rolling rate or a touch-traveling distance obtained when the user manipulates the input device. The clicking rate indicates a number of times that a button element (e.g., a computer mouse, keys of a keyboard or a surface of a touch pad) of the input device is clicked within a unit time. The rolling rate indicates a number of times, a number of steps or a length that a rolling input element (e.g., a wheel or a rolling ball of a computer mouse) of the input device is rolled within a unit time. The touch-traveling distance indicates a distance that is formed by using a gesture or a control device (e.g., a stylus) to travel with continuous touch signals over the input device within a unit time.

The type of the input device connected with the signal transmitter can be identified according to a product ID. The microcontroller of the signal transmitter obtains the manipulation data from the input signals generated by each input behavior. The manipulation data can be a number of times when clicking on the left and right buttons of the computer mouse, keys of the keyboard or the surface of the touch pad of the computer mouse within a unit time. The manipulation data can be a number of rolling steps that is calculated when rolling the wheel of the computer mouse. The manipulation data can be an operating distance that is calculated when performing a gesture on the touch pad (step S403). The above-mentioned calculations can be used to obtain the manipulation data (step S405) and then the manipulation instruction can be determined by querying the lookup table (step S407).

In conclusion, according to the above embodiments of the method for operating a signal transmitter adapted to manipulation behavior and the signal transmitter, rather than the signals processed in between the conventional operating system operated in the computer system and the input device, the method of the present disclosure is operated in firmware of the signal transmitter, or through collaboration of software and hardware in the signal transmitter. The manipulation data is therefore extracted from the input signals in real time, and the corresponding manipulation instruction can be obtained, so that the operating system can directly perform the manipulation instruction.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

1. A signal transmitter adapted to manipulation behavior, comprising:
a microcontroller;
a memory that is electrically connected with the microcontroller, wherein the memory stores a lookup table that records manipulation data and corresponding manipulation instructions, and the lookup table is editable through an editing program operated in a computer host; wherein the microcontroller determines the manipulation instruction based on the manipulation data in real time; and
a signal transmitting circuit, electrically connected with the microcontroller, used to establish a connection for transmitting signals between an input device and the computer host;
wherein the microcontroller receives input signals transmitted by the input device from the signal transmitting circuit, determines the manipulation data in response to the input signals by querying the lookup table, determines a corresponding manipulation instruction based on the manipulation data, and transmits the manipulation instruction to the computer host via the signal transmitting circuit, so that an operating system operated in the computer host executes the manipulation instruction.

2. (canceled)

3. (canceled)

4. The signal transmitter according to claim 1, wherein the manipulation data relates to a clicking rate, a rolling rate or a touch-traveling distance that is formed when manipulating the input device.

5. (canceled)

6. (canceled)

7. The signal transmitter according to claim 1, wherein the memory stores a product ID that is referred to for the microcontroller to recognize the input device, so that the manipulation instruction is determined based on the manipulation data of the input device.

8. (canceled)

9. A method for operating a signal transmitter adapted to manipulation behavior, performed by a microcontroller of the signal transmitter, wherein the method comprises:
receiving input signals transmitted by an input device from a signal transmitting circuit of the signal transmitter;
determining manipulation data in response to the input signals by querying a lookup table stored in a memory that is electrically connected with the microcontroller, wherein the lookup table that records manipulation data and corresponding manipulation instructions is editable through an editing program operated in a computer host;
determining a corresponding manipulation instruction based on the manipulation data in real time; and
transmitting the manipulation instruction to the computer host via the signal transmitting circuit, so that an operating system operated in the computer host executes the manipulation instruction.

10. (canceled)

11. (canceled)

12. The method according to claim 9, wherein the memory stores a product ID that is referred to for the microcontroller to recognize the input device, so that the manipulation instruction is determined based on the manipulation data of the input device.

13. (canceled)

14. The method according to claim 9, wherein the manipulation data relates to a clicking rate, a rolling rate or a touch-traveling distance that is formed when manipulating the input device.

15. (canceled)

16. (canceled)

17. (canceled)

18. The method according to claim 14, wherein the clicking rate indicates a number of times that a button element of the input device is clicked within a unit time.

19. The method according to claim 14, wherein the rolling rate indicates a number of times, a number of steps or a length that a rolling input element of the input device is rolled within a unit time.

20. The method according to claim 14, wherein the touch-traveling distance indicates a distance that is formed by using a gesture or a control device to travel over the input device within a unit time.
